(19) United States
(12) Patent Application Publication
(10) Pub. No.: US 2012/0169113 A1
(43) Pub. Date: Jul. 5, 2012

(54) TRACKED SYSTEM WITH VARIABLE GEOMETRY

(75) Inventor: Giovanni La Spina, La Spezia (IT)

(73) Assignee: OTO MELARA S.p.A., La Spezia (IT)

(21) Appl. No.: 13/327,181

(22) Filed: Dec. 15, 2011

(30) Foreign Application Priority Data
Dec. 15, 2010 (IT) TO 2010 A 000999

(51) Int. Cl. B62D 55/14

(52) U.S. Cl. 305/132

(57) ABSTRACT

A tracked system (10) with variable geometry includes a track (11), which has a portion (11p) having a respective first area (a1), the portion (11p) being, in use, in contact with the ground or the road surface.

At least one driving wheel (12) is coupled to the track (11) and is suited to provide a driving force for the rotation of the track (11). At least one driven wheel (13) is coupled to the track (11). The tracked system (10) includes an actuator (14), which is suited to vary the geometry of part of the track (11). The actuator (14) has an intervention configuration, in which it configures the portion (11p) of the track (11) on at least one second area (a2) which, in use, is in contact with the ground.

This application claims benefit of Serial No. TO 2010 A 000 999, filed 15 Dec. 2010 in Italy and which application is incorporated herein by reference.

To the extent appropriate, a claim of priority is made to the above disclosed application.

### BACKGROUND

The present invention relates to a tracked system and, more in detail, to a tracked system with variable geometry.

It is known that tracked vehicles, in particular those of the military or agricultural type, are provided with a pair of independent tracks, which are respectively mounted on a left and on a right side of the vehicle itself.

It is also known that said tracks are controlled by motorized moving means, which are able to cause the vehicle to perform a rotation movement on a central point, which is also known as pivot movement.

The rotation movement of the vehicle on a central point, also known as pivot or pivoting movement, is particularly stressful for the part of track that is in contact with the ground or with the road surface, both from a mechanical and from an energetic point of view.

From a mechanical point of view, said movement is stressful due to the fact that it develops a sliding friction which is:

oriented in a direction that is substantially orthogonal to the weight force; and

distributed in a non uniform way on the part of track that is contact with the ground or with the road surface.

From an energetic point of view, the stress is caused by the above-mentioned friction, which generates a significant waste of power and torque in order to face the request for a rotation on a central point, in particular in case the vehicle is heavy or long with respect to its axle track (axle track meaning the distance between the respective centers of the two wheels of the same axle) and, therefore, in particular for big agricultural machines or military vehicles provided with heavy loads or heavy armor platings.

The drawbacks described above can be applied both to tracked vehicles provided with rubber tracks and to tracked vehicles provided with metal tracks.

Therefore, an object of the present invention is to describe a tracked system with variable geometry, which allows a reduction of the drawbacks described above.

### SUMMARY

According to the present invention, a tracked system with variable geometry is provided.

According to the present invention, furthermore, a tracked vehicle is provided, which has a tracked system with variable geometry.

### BRIEF DESCRIPTION OF THE DRAWINGS

The invention will now be described with reference to the accompanying drawings, which illustrate a non-limiting embodiment, wherein:

FIG. 1 illustrates a tracked system with variable geometry in a first use configuration according to the present invention; and

FIG. 2 illustrates a tracked system with variable geometry in a second use configuration according to the present invention.

### DETAILED DESCRIPTION

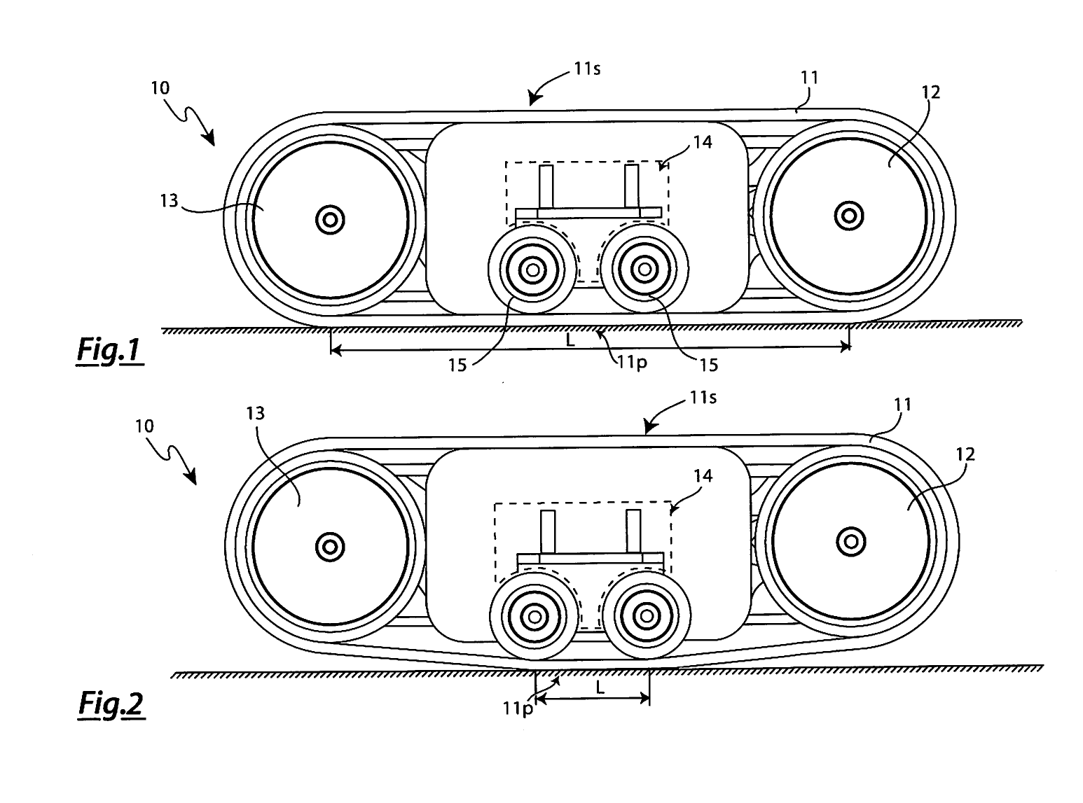

With reference to FIG. 1, number 10 indicates a tracked system with variable geometry as a whole, which comprises a track 11, which presents a first portion 11p having a respective first area that is in contact with the ground and a second portion 11s having a respective second area that is opposite to the previous first portion 11p, and which is tensioned by at least one driving wheel 12 and at least one driven wheel 13, which are both coupled to track 11.

In particular, driving wheel 12 is arranged in correspondence to an end of the track that is oriented towards the front or rear end of a vehicle provided with a pair of tracks 11, while driven wheel 13 is arranged in correspondence to a second end of the track that is oriented towards the opposite end of the vehicle itself.

Driving wheel 12 is coupled to track 11 so as to provide it with a driving force that is sufficient to move the vehicle and, therefore, to cause the track to rotate with respect to the ground.

Driving wheel 12, furthermore, has to be coupled to the track so as to be able to provide a driving force that is sufficient to cause the vehicle to rotate on a central point or to rotate on itself, said movement being known as pivot or pivoting movement.

Tracked system 10 comprises a plurality of actuator means 14, which allow a variation of the geometry of portion 11p in contact with the ground, so that the area in contact with the ground or the road surface can be reduced, passing from a first larger size to a second smaller size, when the pivot movement is carried out.

Actuator means 14 are installed on a side of the track, so that, when system 10 is mounted on the vehicle, said actuator means 14 are arranged inside the axle track of the vehicle itself.

Actuator means 14 preferably comprise, for example, a pair of thrust pistons having a first end that is rigidly connected to a rigid structure of the system, and a second mobile end that acts on the first portion 11p of track 11.

More in detail, the second mobile end acts on one or more thrust wheels 15, thus exerting on them a thrust force having a direction that is substantially orthogonal to the plane on which the first portion 11p of the track lies. In the accompanying figures, there are two thrust wheels 15 for each track 11, said thrust wheels 15 being arranged in a row along a direction of maximum extension of track 11 itself and rotating, furthermore, around parallel axes; due to the effect of the force exerted by the thrust pistons, thrust wheels 15 deform the first portion 11p substantially in correspondence to its central part, namely in a region that comprises the vertical projection of the center of gravity of the vehicle on the ground, thus reducing the area of the above-mentioned first portion that is in contact with the ground or the road surface.

In detail, in a first use configuration, or rest configuration, actuator means 14 are in a rest position and thrust wheels 15 do not intercept the first portion 11p of the track, which, therefore, lies on the ground with an area having a first value a1.

In a second use configuration, or intervention configuration, which can be freely selected by a user of the vehicle on which system 10 according to the present invention is installed or automatically activated in concurrence with the execution of the pivot movement, actuator means 14 shift from said rest position to an operating position, in which thrust wheels 15 act on part of the first portion 11p of track 11, thus modifying its shape—if the track is observed laterally—and bringing the area of portion 11p that is in contact with the ground or the road surface to a second value a2, which is lower than the previous value a1.

When system 10 is in the second use configuration, driving wheel 12 and driven wheel 13 are raised with respect to the ground or the road surface.

As a consequence, the whole weight of the vehicle is released on an area having a value a2 that is lower than value a1.

If one assumes to install a pair of systems 10 according to the present invention on a vehicle and to respectively position them on the left side and on the right side of the vehicle itself, and if one defines T [Nm] as the torque needed to cause said vehicle to perform a pivot movement, during which, as mentioned above, the vehicle is caused to rotate on a central point, one obtains:

$$T α \frac{L}{C}$$

wherein L [m] corresponds to the length of portion 11p of the track that is in contact with the ground or with the road surface, while C [m] indicates the distance between two tracks 11 mounted on the vehicle, also known as axle track.

Now, considering that the axle track is defined in an unchangeable manner by a given type of vehicle, the element that can vary is length L.

As a consequence, when length L of the first portion 11p is reduced due to the configuration of system 10 in the second use configuration described above, the torque that has to be delivered to the tracks in order to allow the vehicle to rotate with a pivoting movement is reduced and, together with it, also the wear and the waste of energy to be used during the operation.

Obviously, the discussion concerning the variation of length L of the first portion 11p of track 11 that is in contact with the ground corresponds to a procedure for the variation of area A of portion 11p of track 11 that is in contact with the ground. Indeed, the width of track 11 is fixed and it cannot be changed; for this reason, considering that track 11 lies on the ground with its first portion 11p having an area that has a substantially rectangular shape, it is clear that a variation in length L leads to a variation in the area that is contact with the ground, thus reducing only two of the sides of the above-mentioned rectangle. The other two sides, instead, which are defined by the width of track 11, remain constant.

Furthermore, it should be pointed out that, using constructive techniques of the known type, the force that has to be exerted by actuator means 14 in order to reduce torque T necessary for the pivoting movement can simply be a fraction of the weight of the entire vehicle and, in case the vehicle is provided with a moving system of the hydraulic type, the necessary energy can be drawn from the existing hydraulic circuit.

The advantages of the tracked system with variable geometry according to the present invention are known in the light of the previous description. In particular, said system allows a rotation movement of a tracked vehicle on itself, assuring at the same time a reduced wear of the track, a lower energy waste, and a higher efficiency.

The more often the tracked vehicle is used in hostile or restricted environments, where it is necessary to perform repeated pivot movements, the more relevant is the advantage of performing said pivot movement in the most efficient way possible; similarly, the larger is the mass of the tracked vehicle, the more relevant is the advantage of performing the pivot movement in the most efficient way possible.

Finally, thrust wheels 15 can act on the track and modify its shape and, hence, the area and length L with which it lies on the ground, thus making them reach a plurality of different values, so as to adjust the reduction of the above-mentioned area and length to the value desired by the user.

1. Tracked system with a variable geometry, comprising:
a wheel belt, comprising a portion having a respective first area; said portion in use being in contact with the land or roadway;
at least a traction wheel, coupled to said wheel belt and configured to supply motive power for rotation of said wheel belt; and
at least a driven gear, coupled to said wheel belt;
actuator means for varying geometry of part of said wheel belt; said actuator means comprising an intervention configuration wherein said portion of said wheel belt includes at least a second area in use being in contact with the land; said second area being different from said first area.

2. The tracked system according to claim 1, wherein in said intervention configuration said second area is smaller than said first area.

3. The tracked system according to claim 1, wherein said second area is:
in centered position with respect to a projection on the ground of a center of gravity of a vehicle upon which said system is configured to mounted; and
enclosed within said first area.

4. The tracked system according to claim 1, wherein said actuator means comprise a plurality of thrusting pistons, having a first end fixed to a rigid structure of said tracked system and a second movable end acting on said portion.

5. The tracked system according to claim 1, further comprising a plurality of thrusting wheels of said portion of said wheel belt; said plurality of thrusting wheels being configurable upon a plurality of different positions.

6. The tracked system according to claim 4, wherein said second movable end is connected to said thrusting wheels; said thrusting wheels being configured for exerting a thrusting power upon said portion; said thrusting power being substantially orthogonal with respect to the land upon which in use said portion of said wheel belt rests.

7. The tracked system according to claim 5, wherein said plurality of thrusting wheels comprises at least a pair of wheels parallely oriented and row-arranged along a direction of maximum extension of said wheel belt.

8. The tracked system according to claim 1, wherein said actuator means are hydraulic pistons.

9. The tracked system according to claim 1, wherein in said intervention configuration said traction wheel and said driven gear, are in use at a respective height with respect to a flat land.

10. The tracked system according to claim 1, wherein said portion of said wheel belt in use in contact with the land or a roadway has a length and wherein in said intervention configuration said length is reduced with respect to a rest configuration of said actuator means.

11. The tracked system according to claim 5, wherein in said rest configuration said thrusting wheels do not encounter said portion.

12. A tracked vehicle having a tracked system with variable geometry, comprising:
a wheel belt, comprising a portion having a respective first area; said portion in use being in contact with the land or roadway;
at least a traction wheel, coupled to said wheel belt and configured to supply motive power for rotation of said wheel belt; and
at least a driven gear, coupled to said wheel belt;
actuator means for varying geometry of part of said wheel belt; said actuator means comprising an intervention configuration wherein said portion of said wheel belt includes at least a second area in use being in contact with the land; said second area being different from said first area.

13. The tracked vehicle according to claim 12, comprising at least a wheel belt upon a side respectively left and right.
